(19) United States
(12) Patent Application Publication
(10) Pub. No.: US 2017/0121123 A1
(43) Pub. Date: May 4, 2017

(54) WOOD BOARD FEEDING SYSTEM WITH ALIGNMENT FEATURE

(71) Applicant: Carbotech International, Plessisville (CA)

(72) Inventors: Mathieu LAFLAMME, Victoriaville (CA); Francis LEPAGE, Dolbeau-Mistassini (CA)

(21) Appl. No.: 15/214,677

(22) Filed: Jul. 20, 2016

Related U.S. Application Data
(60) Provisional application No. 62/248,853, filed on Oct. 30, 2015.

(51) Int. Cl. B65G 47/244; B27B 31/04; B27B 25/00

(52) U.S. Cl. CPC B65G 47/2445; B27B 25/00; B27B 31/04; B65G 2201/0282; B65G 2203/0225

(57) ABSTRACT

A wood board feeding system for positioning in a parallel orientation longitudinal pieces of lumber. It comprises a feeding conveyor assembly configured to receive and convey the longitudinal pieces of lumber over a conveying area in a conveying direction. The feeding conveyor assembly comprises a first conveyor sub-assembly and a second conveyor sub-assembly, both comprising a conveyor for conveying the longitudinal pieces of lumber about one of their ends and a motor driving the conveyor at a conveying speed. The first conveyor and the second conveyor are disposed side-by-side with respect to the conveying direction, thereby the first conveyor sub-assembly and the second conveyor sub-assembly position a respective one of the two opposite ends of the longitudinal pieces of lumber.

### CROSS-REFERENCE TO RELATED APPLICATION

This application claims priority from US provisional patent application U.S. 62/248,853 filed Oct. 30, 2015, the specification of which is hereby incorporated herein by reference in its entirety.

### BACKGROUND

(a) Field

The present description relates to industrial machinery used in wood mills. More particularly, the present description relates to a wood board feeding system.

(b) Related Prior Art

It is well known in the art that in a sawmill or a lumber mill, transportation of the longitudinal pieces of lumber requires the use of conveyors. Usually, the longitudinal pieces of lumber emerge from the mill in random order onto a feeding conveyor. Certain given stages of the transformation process require that the longitudinal pieces of lumber be regularly spaced apart on a conveyor. It is therefore necessary to provide a system for transferring the longitudinal pieces of lumber from the feeding conveyor to another conveyor such that the longitudinal pieces of lumber are disposed in a parallel manner and regularly spaced thereon. In order to be efficient, lumber transfer systems should allow handling and transfer of any type, size and shape of longitudinal pieces of lumber such as stem, saw log, wood plank, beam and the like. Furthermore, they should also allow a high transfer rate of longitudinal pieces of lumber. In fact, the efficiency of a lumber mill generally depends greatly on the production rate attainable. The number of longitudinal pieces of lumber transferred per minute from one conveyor to another is thus a factor affecting greatly the production rate of lumber mills.

Examples of transfer lumber systems known to the Applicant are described in the following Canadian patents and/or patent applications: 1,171,020; 1,228,873; 2,133,927; 2,148,322; 2,151,768; 2,185,609; 2,185,620; 2,238,231; 2,271,175; and 2,577,656. Additionally, following US patents also describe transfer lumber systems: U.S. Pat. No. 267,991, U.S. Pat. No. 3,147,842, U.S. Pat. No. 4,869,360, U.S. Pat. No. 4,945,976, U.S. Pat. No. 5,419,425, U.S. Pat. No. 5,518,106, U.S. Pat. No. 5,662,203, U.S. Pat. No. 6,564,926, U.S. Pat. No. 6,702,096, U.S. Pat. No. 6,956,197, and U.S. Pat. No. 8,104,604B2.

It is also well known in the art that longitudinal pieces of lumber arriving on the feeding conveyor prior to being transferred and equally spaced by the transfer system are often intermingled and comprise different pieces of various lengths. Prior to being transferred, the longitudinal pieces of lumber are accumulated on an accumulating portion of the feeding conveyor, where typically, conveying chains roll at high speed. When a short longitudinal piece of lumber is followed by a long one, the long longitudinal piece of lumber has a tendency to pivot around the short longitudinal piece of lumber. Since the extremity of the longer longitudinal piece of lumber stands out relative to the downstream shorter longitudinal piece of lumber, this longer extremity is driven by the chains, and/or in some cases, by a pushing action of other following longitudinal pieces of lumber, and this situation leads to a problem where the transfer system will load the long piece lumber together with the short one, while only the short longitudinal piece of lumber should have been transferred. When such problem occurs, production must be stopped and an operator must space out and put the longitudinal pieces of lumber back in order. Such a problem commonly occurs in lumber mills and affects the overall efficiency of the mills.

Another problem arising from the intermingled longitudinal pieces of lumber is that the longitudinal pieces of lumber when fed to the wood board feeding system sometimes take different angles that need to be corrected before exiting the system.

Hence, in light of the aforementioned issues, there is a need for an improved system which, by virtue of its design and components, would be able to overcome or at least minimize some of the aforementioned prior art problems.

### SUMMARY

According to an embodiment, there is provided a wood board feeding system for positioning in parallel longitudinal pieces of lumber fed to the wood board feeding system in a substantially transversal manner, wherein the longitudinal pieces of lumber each comprise a first end and a second end opposite the first end. The wood board feeding system comprises a feeding conveyor assembly configured to receive and convey the longitudinal pieces of lumber in a conveying direction which is substantially transversal to the longitudinal pieces of lumber. The feeding conveyor assembly comprises a first conveyor sub-assembly which comprises a first conveyor for conveying at least the first end of the longitudinal pieces of lumber and a first motor driving the first conveyor at a first conveying speed, and a second conveyor sub-assembly which comprises a second conveyor for conveying at least the second end of the longitudinal pieces of lumber and a second motor driving the second conveyor at a second conveying speed, the first conveyor sub-assembly and the second conveyor sub-assembly being disposed side-by-side with respect to the conveying direction. At least one of the first conveyor sub-assembly and the second conveyor sub-assembly laterally positions a corresponding one of the first end and the second end of the longitudinal pieces of lumber such that the longitudinal pieces of lumber are positioned substantially in parallel to each other.

According to an aspect, the wood board feeding system further comprises a detection system detecting positions of the longitudinal pieces of lumber on the feeding conveyor assembly and transmitting position signals accordingly, and a controller receiving the position signals from the detection system and transmitting control signals to at least one of the first motor and the second motor thereby individually controlling the first conveying speed and the second conveying speed.

According to an aspect, the wood board feeding system further comprises blocking fingers moveable between a blocking position and an unblocking position. The blocking fingers, when in the blocking position, prevent the longitudinal pieces of lumber from being conveyed while, when in the unblocking position, allow the longitudinal pieces of lumber to be conveyed further in the conveying direction.

According to an aspect, the wood board feeding system further comprises a conveyor surface. The blocking fingers, when in the blocking position, extend above the conveyor surface, and when in the unblocking position, are positioned flush with or under the conveyor surface.

According to an aspect, the wood board feeding system further comprises a blocking finger motor and a shaft driven by the blocking finger motor driving one of the blocking fingers between the blocking position and the unblocking position.

According to an aspect, the wood board feeding system further comprises an entrance, an exit and positioning fingers extending upwardly about the exit.

According to an aspect, the wood board feeding system further comprises a conveying area having an entrance and an exit and a grasping assembly located about the exit. The grasping assembly is adapted for removing the longitudinal pieces of lumber from the conveying area.

According to an aspect, the wood board feeding system further comprises a grasping motor driving the grasping assembly at a grasping speed.

According to an aspect, the wood board feeding system further comprises pegs located about one of the first conveyor and the second conveyor. The pegs are adapted for entering in contact with the longitudinal pieces of lumber, thereby pushing the longitudinal pieces of lumber across the conveying area.

According to an aspect, the wood board feeding system further comprises a third conveyor sub-assembly which comprises a third conveyor for conveying the longitudinal pieces of lumber and a third motor driving the third conveyor at a third conveying speed. The third conveyor is positioned downstream at least one of the first conveyor and the second conveyor.

According to an aspect, one of the first conveyor and the second conveyor consists in one of a chain conveyor and a belt conveyor.

According to an aspect, the first conveying speed is in a first direction and the second conveying speed is in a second direction opposed the first direction.

According to an aspect, the first conveying speed is different from the second conveying speed.

According to an aspect, the wood board feeding system further comprises a conveyor surface adapted to receive the longitudinal pieces of lumber and the conveyor surface is in a substantially horizontal plane.

According to another embodiment, there is provided a method for positioning in parallel longitudinal pieces of lumber, each comprising a first end and a second end opposite the first end. The method comprises feeding and conveying the longitudinal pieces of lumber in a conveying direction from an entrance to an exit, and positioning one of the first end and the second end of the longitudinal pieces of lumber such that the longitudinal pieces of lumber are positioned substantially in parallel to each other.

According to an aspect, the positioning comprises controlling at least one of a first conveying speed of a first end of the longitudinal pieces of lumber and a second conveying speed of a second end of the longitudinal pieces of lumber.

According to an aspect, the method further comprises detecting positions of the longitudinal pieces of lumber and transmitting position signals accordingly to thereby control at least one of the first conveying speed and a second conveying speed.

According to an embodiment, there is provided a wood board feeding system for positioning in parallel longitudinal pieces of lumber fed to the wood board feeding system in a substantially transversal manner, wherein the longitudinal pieces of lumber each comprise a first end and a second end opposite the first end. The wood board feeding system comprises a first conveyor for conveying the first end of the longitudinal pieces of lumber at a first conveying speed, whereby the first conveyor laterally positions the first end of the longitudinal pieces of lumber such that the longitudinal pieces of lumber are positioned substantially in parallel to each other.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic top view of an embodiment of a wood board feeding system, including an outfeed conveyor;

FIG. 2 is a schematic top view of a portion of a wood board feeding system according to an embodiment, the wood board feeding system being shown along with a variety of different longitudinal pieces of lumber which may be conveyed thereon;

FIG. 3 is a side view of the portion of the wood board feeding system shown in FIG. 2;

FIG. 4 is an enlarged view of a portion of is the wood board feeding system shown in FIG. 3;

FIG. 5 is a schematic top view of a detection system with respect to the conveying area of the wood board feeding system shown in FIG. 1;

FIG. 6 is a picture showing a top perspective view of a wood board feeding system according to an embodiment; and

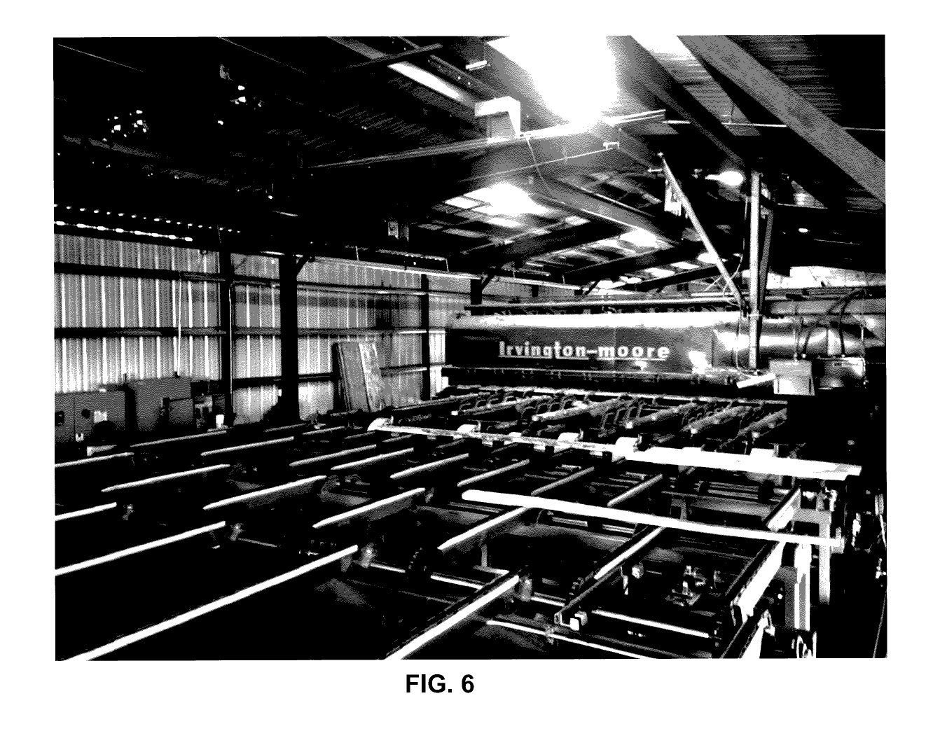

FIG. 7 is a flow chart illustrating steps performed in one or more embodiments.

It will be noted that throughout the appended drawings, like features are identified by like reference numerals.

### DETAILED DESCRIPTION

In the following description, the same numerical references refer to similar elements. The embodiments, geometrical configurations, materials mentioned and/or dimensions shown in the figures or described in the present description are embodiments only, given for exemplification purposes only.

Furthermore, to preserve the clarity of the drawings, some reference numerals may have been omitted if they were already identified in a preceding figure.

Moreover, although the present disclosure describes methods and systems for improving the conveyance or transfer of longitudinal pieces of lumber from a feeding conveyor assembly to an outfeed conveyor in a lumber mill, it may be used with other types of objects and for other purposes, in other fields, as apparent to a person skilled in the art. For this reason, expressions such as “conveying”, “transferring”, “wood board”, “lumber”, “mill”, etc., used herein should not be taken as to limit the scope of the present description and includes all other kinds of objects or fields with which the present description could be used and may be useful.

Moreover, in the context of the present description, the expressions “system”, “assembly”, “unit”, “device” and any other equivalent expression and/or compound words thereof known in the art will be used interchangeably. Furthermore, the same applies for any other mutually equivalent expressions, such as “wood board”, “lumber”, “elongated longitudinal piece of lumber”, “log”, “plank” and the like, or “segment”, “portion” and “section”, as well as “unblocked” and “conveying”, for example, as also apparent to a person skilled in the art. Furthermore, and also in the context of the present description, the expressions “align”, “orient”, “reorient” and “position” may also be used interchangeably, as well as “finger” and “stopper”, or even “second”, “subsequent” and “upstream”, as also apparent to a person skilled in the art.

In addition, although the embodiments of the present description as illustrated in the accompanying drawings may comprise various components, and although the embodiments of the wood board feeding system as shown consists of certain geometrical configurations as explained and illustrated herein, not all of these components and geometries are essential to the description and thus should not be taken in their restrictive sense, i.e. should not be taken as to limit the scope of the present description. It is to be understood, as also apparent to a person skilled in the art, that other suitable components and cooperation therebetween, as well as other suitable geometrical configurations may be used for the wood board feeding system and corresponding parts according to the present description, as will be briefly explained hereinafter and as can be easily inferred therefrom by a person skilled in the art, without departing from the scope of the description.

Broadly described, the present description, as illustrated in the accompanying drawings, relates to a wood board feeding system for improving the transfer of longitudinal pieces of lumber from a feeding conveyor assembly to an outfeed conveyor, and more particularly the conveyor assembly and process taking place between the entrance by longitudinal pieces of lumber into the feeding conveyor assembly to the exit of the feeding conveyor assembly downstream.

As previously explained, and as will be understood in greater detail hereinbelow, the present description is a substantial improvement over conventional wood board feeding systems or methods in that it comprises components and features for individually controlling the orientation of and the space between longitudinal pieces of lumber in response to detection signals so as to place the longitudinal pieces of lumber in an optimal configuration for transfer to the outfeed conveyor.

An advantage resulting from the present description is that human intervention is substantially reduced in order to ensure a proper alignment between a pair of neighbor longitudinal pieces of lumber (i.e., a pair of a first and a second longitudinal pieces of lumber, the first one being conveyed downstream, and the second or “subsequent” one, following upstream along the feeding conveyor assembly), especially in cases when one is much longer than the other, and that the resulting parallel longitudinal pieces of lumber having thus been realigned or reoriented by the wood board feeding system can thus be individually transferred from the feeding conveyor to a outfeed conveyor in a much improved manner (faster, more reliable, etc.), thereby significantly improving productivity and other desirable factors related to the operation of a mill.

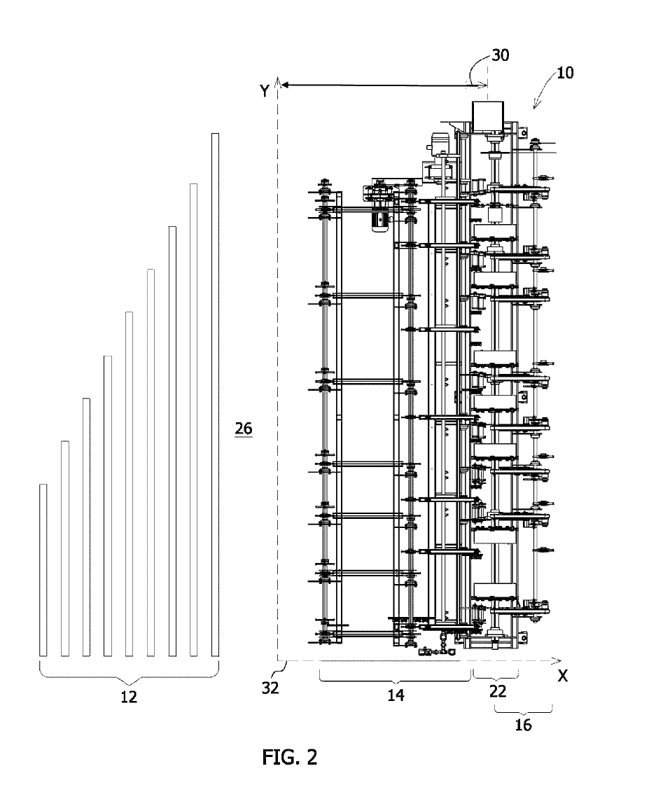

Referring to FIG. 2, there is shown a wood board feeding system 10 according to an embodiment. The wood board feeding system 10 is used for individually transferring longitudinal pieces of lumber 12 fed in a substantially transverse orientation from a feeding conveyor assembly 14 to an outfeed conveyor 16, and regularly spacing the longitudinal pieces of lumber 12 on said outfeed conveyor 16 in a parallel orientation.

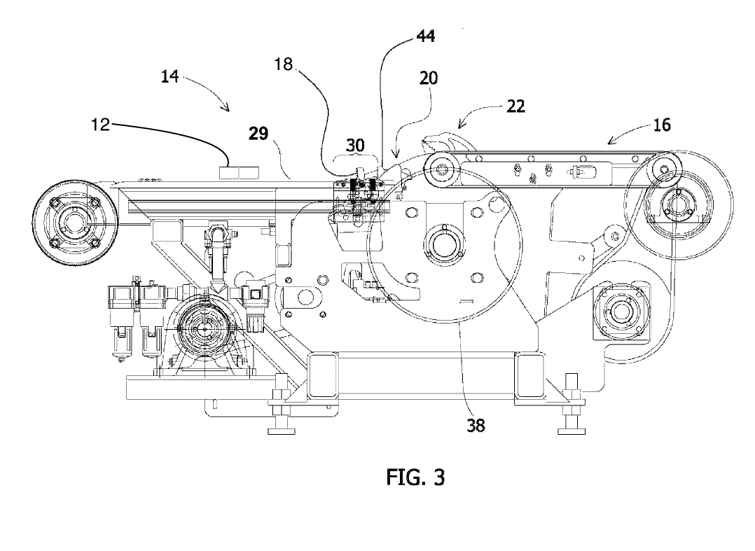

The feeding conveyor assembly 14, e.g., a belt or a chain conveyor, has a longitudinal conveying area 26 (best shown in FIG. 3) over which substantially transversal longitudinal pieces of lumber 12 are conveyed. Typically, the feeding conveyor assembly 14 receives longitudinal pieces of lumber 12 accumulating thereon from a plant conveyor which is part of the mill. The longitudinal pieces of lumber 12 may be intermingled and are generally of various lengths and widths. Although it is not a prerequisite, the longitudinal pieces of lumber 12 conveyed on the feeding conveyor assembly 14 are aligned according to the reference side 32 (often referred to as the 0″ side). Alternatively, they may be placed at any suitable position. For example, the longitudinal pieces of lumber 12 may be generally centered with respect to the conveying area 26. As shown, the longitudinal pieces of lumber 12 are conveyed in a direction substantially transverse to their length even though they are not systemically oriented in a transverse manner with respect to the conveying flow.

According to an embodiment, the feeding conveyor assembly 14 comprises a plurality of belt conveyors, but it may also consist of chain conveyors. Still, the feeding conveyor assembly 14 may comprise lug chains provided with pegs entering in contact with longitudinal pieces of lumber 12 and pushing them to move across the conveying area 26 of the feeding conveyor assembly 14. The pegs may be equally spaced apart. Also, with respect to one lug chain versus another, pegs may be differently spaced apart, having different distances between two subsequent pegs. Still, some of the lug chains may feature no pegs to ease reorientation of the longitudinal pieces of lumber 12. Alternatively, treaded belts with high points distant from each other may be used to replicate the functions of the discussed pegs.

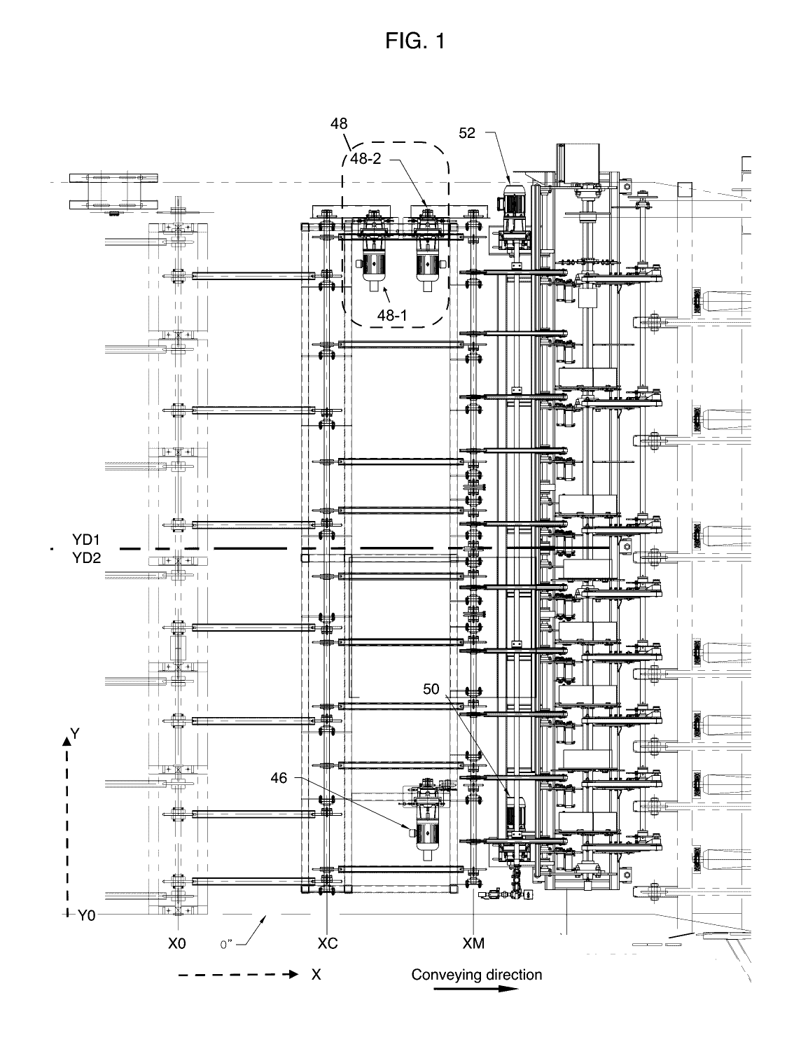

Also referring to FIG. 1, the feeding conveyor assembly 14 consists of a first conveyor sub-assembly and a second conveyor sub-assembly. The first conveyor sub-assembly comprises a first motor 46 that drives a first conveyor thereby controlling the advancement of longitudinal pieces of lumber 12, or more precisely the end of the longitudinal pieces of lumber 12 located in the first conveying area A1 extending from the 0″ side 32 to the distal line Y_{D1} and from the lumber feeding entry X_{c} to downstream distance X_{M}. The second conveyor sub-assembly comprises a second motor 48 that drives the second conveyor thereby controlling the advancement of the longitudinal pieces of lumber 12, or more precisely the end of the longitudinal pieces of lumber 12 located in the second conveying area A2 extending from the distal line Y_{D2} to the extent of the width of the feeding conveyor assembly 14 and from X_{c} to X_{M}.

As illustrated on FIGS. 1, 2 and 5 wherein the feeding conveyor assembly 14 is illustrated as a plan with an X-axis and a Y-axis, the first conveyor conveys through friction, or by contact with the pegs provided on the lug chains, the longitudinal pieces of lumber 12 within the limits of area A1 inducing advancement on the portion of the pieces of longitudinal pieces of lumber 12 at a first conveying speed S1 controlled by the first motor 46. The second conveyor similarly induces advancement of the portion of the longitudinal pieces of lumber 12 located in the second conveying area A2 according to a second conveying speed S2. The difference between the value and direction of conveying speeds S1 and S2 induces a modification in the orientation of the longitudinal pieces of lumber 12 therefore allowing a rectification of the orientation of the longitudinal pieces of lumber 12 in a parallel disposition and a transversal orientation with respect to the conveying direction. Accordingly, the first conveyor sub-assembly and second conveyor sub-assembly, each by positioning a respective one of the ends of the longitudinal pieces of lumber 12, rectify their orientation. In other words, according to an embodiment, the speed of at least one of the first conveyor sub-assembly and second conveyor sub-assembly are controlled to slow down, or accelerate a respective end of the longitudinal pieces of lumber the first conveyor sub-assembly and second conveyor sub-assembly 12 in order to make them all parallel to each other.

The wood board feeding system 10 also comprises a third conveyor sub-assembly and a fourth conveyor sub-assembly each comprising a corresponding third motor 50 and fourth motor 52 working in combination with a third conveyor and a fourth conveyor. The third conveyor sub-assembly and the fourth conveyor sub-assembly control the conveying speed of the longitudinal pieces of lumber 12 within a third conveying area A3 and a fourth conveying area A4 extending from the stream point X_{M} to the limit of the outfeed conveyor 16. As with first and second motors 46 and 48, the third and fourth motors 50 and 52, under control of the controller 24, drive respective conveyors and thereby control advancement and orientation of the longitudinal pieces of lumber 12 through control of the conveying speeds S3 and S4 of the belts or chains of the third and fourth conveyors conveying ends of longitudinal pieces of lumber 12 in the areas A3 and A4.

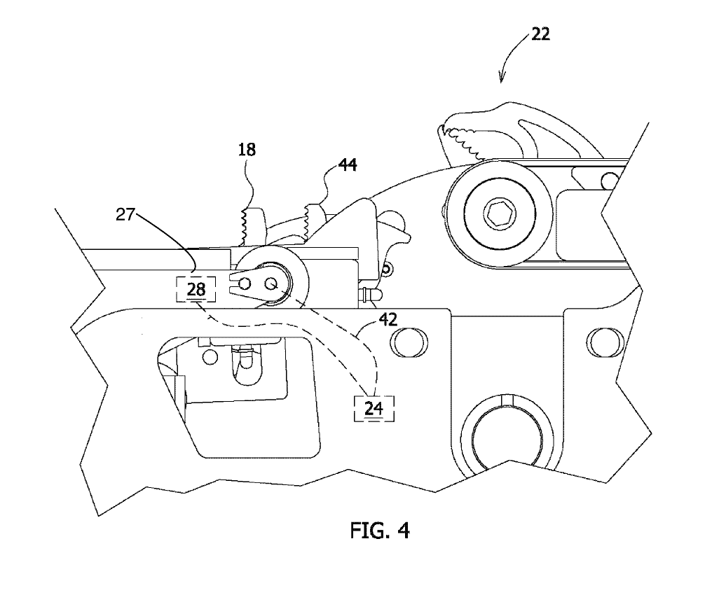

Also referring to FIG. 4, detection system 27 may use any kind of detectors 28, such as photocells or ultrasound detectors, or cameras, are used to detect a lumber presence in the detection corridor 30 covering the conveying areas A1, A2, A3 and A4. The signals generated by the detection system 27 are transmitted to the controller 24, which signals the motors 46, 48, 50 and 52 to perform at particular conveying speeds and direction S1, S2, S3 and S4 in order to impose orientation and space between the longitudinal pieces of lumber 12.

Accordingly, the four motors 46, 48, 50 and 52 are individually and continuously under control of the controller 24 which determines the speed of the four motors 46, 48, 50 and 52 and therefore the advancement of each longitudinal piece of lumber 12 based on the location of the longitudinal piece of lumber 12 with respect to the conveying areas A1, A2, A3 and A4 of the feeding conveyor assembly 14. This requires continuous correction of the speed of each end of the longitudinal pieces of lumber 12 and therefore rectifies the orientation of the longitudinal pieces of lumber 12 individually as to control the space to be left between neighboring longitudinal pieces of lumber 12.

Accordingly, longitudinal pieces of lumber 12 are all reoriented (when needed) in a transversal manner to the conveying direction and spaced apart at the desired space when arriving to the outfeed conveyor 16 and therefore optimizing the subsequent processes.

It should be noted that even though the lines Y_{D1} and Y_{D2} are shown as being coaxial, they can be at different distances from the reference side 32 (Y₀) according to the Y-axis to be, for instance, better adapted to modify the orientation of longitudinal pieces of lumber 12 of different lengths along the travel path. The same applies to the line X_{C} being illustrated as a single line dividing an upstream portion and a downstream portion of the feeding conveyor assembly 14.

Alternatively, a set of complementary motors, for instance motors 48-1 and 48-2 (see FIG. 1) may be configured to replace the above discussed second motor 48, with the motor 48-1 turning in a first direction and the motor 48-2 turning in the opposite direction. Therefore, based on the direction to drive an end of a longitudinal piece of lumber 12, the controller 24 would command one of the motor 48-1 or the motor 48-2 to work at a particular conveying speed.

The number of distinct conveying areas of the feeding conveyor assembly 14 is herein illustrated as four (4), but a person skilled in the art would recognize that, based on constraints, the number of conveying areas, and ergo the number of conveyor sub-assemblies, individually under control of the controller 24 could be limited to two (2) or increased without departing from the scope of the description. Furthermore, the number of conveying areas may also be odd (for instance three (3) with two areas close to the reference side 32 and one distant from the reference side 32) as long as the disposition and surface of the conveying areas allow reorientation and conveying of longitudinal pieces of lumber 12 over the whole conveying area 26.

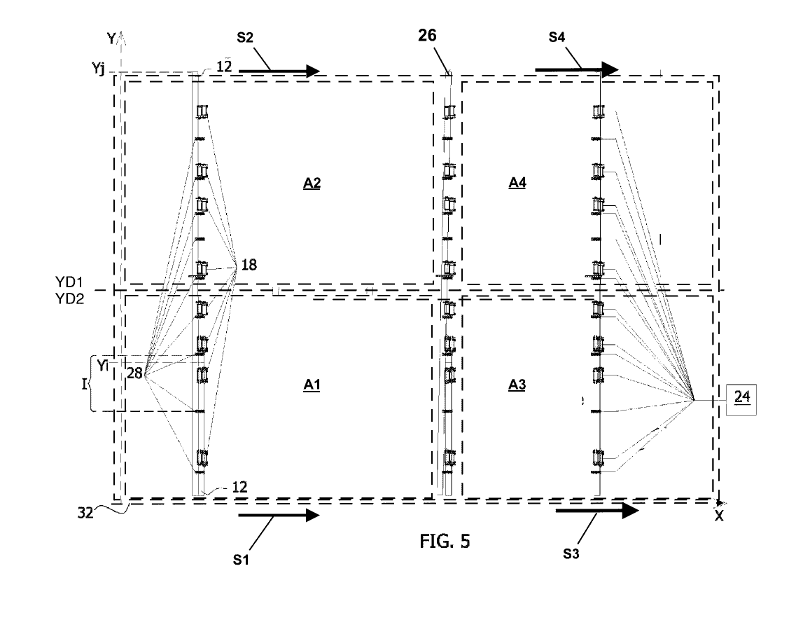

Now referring to FIGS. 2 and 5, detectors 28 (best shown in FIG. 5) used for monitoring presence longitudinal piece of lumber 12 along a detection corridor 30 (shown in FIG. 2) of the longitudinal conveying area 26 of the feeding conveyor assembly 14 are located transversally to the conveying area 26, in line with one another, although other suitable dispositions may be used with the present embodiment, as apparent to a person skilled in the art.

The detection corridor 30 may consist either of a detection line, area, or a lane having a predetermined width, extending continuously or partially from one side to the other of the longitudinal conveying area 26, and over which each longitudinal piece of lumber 12 conveyed will pass or cross.

The detectors 28 may be of any kind, such as photocells or ultrasound detectors, or cameras, as long as they can detect a lumber presence in the detection corridor 30. While they are placed along the detection corridor 30, underneath the conveying area 26, they may also be placed over the conveyor surface 29 or on the side of each belt forming the conveying area 26. Moreover, the detectors 28 may be positioned at any suitable distance of the conveying area 26, so long as they each adequately detect the lumber presence within the associated segment of the detection corridor 30. By lumber presence, it is understood that the detectors 28 will detect the presence of a lumber segment or portion in the “field of view” or “field of detection” of the detectors 28. In other words, the detectors 28 provide indication as to up to where a longitudinal piece of lumber 12 extends from the 0″ side 32 along the transverse detecting corridor.

As illustrated in FIGS. 1 and 5, the 0″ side 32 of the conveying area 26 can be considered as an X-axis, each longitudinal piece of lumber 12 having one end aligned with the axis, and the other end of the longitudinal pieces of lumber 12 extending to a different height Y. For example, in the embodiment illustrated in FIG. 5, nine detectors 28 are shown with respect to three detection lines. Starting from the 0″ side (or X-axis), if the first two detectors 28 detect a lumber presence, and the subsequent detectors 28 (third detector to the ninth) do not detect any lumber presence, it can be considered that the lumber's length extends from the 0″ side 32 to a height Yi, in the interval I between the second and third detectors 28. It is worth mentioning that depending on the applications for which the wood board feeding system 10 is intended, the detectors 28 may or may not be equally spaced from one another.

Now referring to FIGS. 4 and 5 and according to an embodiment, the controller 24 is adapted to determine the individual orientation of the longitudinal pieces of lumber 12 based on received signals from the detection system 27. For instance, using an algorithm involving time and position data, the controller 24 determines current position and orientation of the longitudinal pieces of lumber 12 currently occupying the conveying area 26. Accordingly, by inputting changes in conveying speeds while continuous monitoring the position and orientation of the longitudinal pieces of lumber 12, the controller 24 is able to orient the longitudinal pieces of lumber 12 in a transversal manner with respect to the conveying direction.

It is also worth mentioning that instead of having a plurality of detectors 28 to be used for detecting a presence or a given length of a given longitudinal piece of lumber 12, the detection system 27 make take other suitable detecting means, such as a scanner for example, could be used for recognizing a given profile of a first longitudinal piece of lumber 12, and comparing it with the profile of a second or subsequent longitudinal piece of lumber 12, in order to selectively, independently and operatively control corresponding blocking fingers 18 in order to ensure that the second longitudinal piece of lumber 12, will not rotate about the first longitudinal piece of lumber 12, and so as to ensure that these two longitudinal pieces of lumber 12 are disposed in substantial parallel relationship with one another and appropriately spaced apart, prior to being dispensed out of the exit 20 of the feeding conveyor assembly 14, in order to improve individual transfer of the longitudinal pieces of lumber 12 by the grasping assembly 22 toward the outfeed conveyor 16.

Each detector 28 is individually linked or connected, e.g., by wire, to at least one input device of a controller 24. Wireless connections from the detectors 28 to the controller are also possible. The controller 24 receives individual and independent detecting signals from each detector 28.

Referring to FIGS. 3 and 4, there is illustrated the process of the longitudinal pieces of lumber 12 when exiting the feeding conveyor assembly 14. Motorized blocking fingers 18 may be located downstream of the detection corridor 30, or in other words somewhere between the detection corridor 30 and the exit 20 of the feeding conveyor assembly 14, or even within the detection corridor 30. The blocking fingers 18 are for blocking or stopping a longitudinal piece of lumber 12 arriving at the exit 20 (aka delivering end) of the feeding conveyor assembly 14, preventing the longitudinal piece of lumber 12 from reaching an outer edge of a disk 38 while waiting to be transferred by the grasping assembly 22. According to an embodiment, the blocking fingers 18 are placed in line with one another, and close to the detectors 28.

While not mandatory, each blocking finger 18 may be individually controlled and capable of moving between a blocking position and an unblocking position. The blocking position consists of a raised position, where the blocking fingers 18 extend above the conveying area 26. In the unblocking position, the blocking fingers 18 may be lowered at the conveying area 26 level, or placed underneath it. The blocking fingers 18 can be moved or rotated by connecting them to a shaft and to motorized or actuating devices, such as motors, pneumatic or hydraulic cylinders, and the like. The blocking position (also referred to herein as “blocking configuration”) corresponds to any suitable configuration in which the blocking finger 18 locally obstructs the passage of lumber and the unblocking position (also referred to herein as “unblocking configuration” or “conveying configuration”) corresponds to any suitable configuration in which the blocking finger 18 locally allows passage of the lumber along the conveyor surface 29.

Similarly to what was discussed in regards to the detectors 28, the blocking fingers 18 need not be disposed along a straight line, and may be placed in other suitable manners next to, downstream, or about their associated detectors 28, depending on the particular applications for which the wood board feeding system 10 is intended, and the desired end results, as can be easily understood by a person skilled in the art.

Both the detectors 28 and the motorized blocking fingers 18 are connected to the controller 24, (as shown in FIG. 4), which is the one controlling the speeds of the motors 46, 48, 50 and 52 (as shown on FIG. 1), and which is, according to an embodiment, a PLC (Programmable Logic Controller). The controller 24 may consist of a single PLC or may be distributed in different PLCs. Of course, other types of controllers may be used, such as a server or a PC (personal computer) or in its simplest form, a connecting switch board for interconnecting relays. The controller 24 is additionally provided with outputs 42 for sending independent control signals to the motorized blocking fingers 18 respectively. The control signals are sent in response to the detecting signals, for moving the respective blocking fingers 18 for which a lumber presence is detected from a blocking to an unblocking position and otherwise keeping the respective motorized blocking fingers 18 in their blocking position. Between each longitudinal piece of lumber 12 detected, the blocking fingers 18 may be kept in an unblocking position, or may return to a blocking position.

Still referring to FIGS. 3 and 4, positioning fingers 44 are placed right after (or in other words, “downstream of”) the blocking fingers 18, near the exit of the feeding conveyor assembly 14. The positioning fingers 44 rise up or halt the longitudinal pieces of lumber 12 that have passed the blocking fingers 18 in the proper location and position so that they may be adequately grasped or pinched by the grasping assembly 22.

The grasping assembly 22 may be of any type and is mounted on disks 38 and made of a tooth and a lumber grasping arm, acting as pliers, a.k.a. a gripping assembly, whose action is controlled by the controller 24. The rotation of the disks 38 is also controlled by the controller 24. More particularly, longitudinal pieces of lumber 12 freed by the blocking fingers 18, and halted by the positioning fingers 44 are grasped between the tooth and the grasping fingers (a.k.a. by the gripping assembly) and regularly transferred onto the outfeed conveyor 16, since the disks 38 and outfeed conveyor belts rotate at an even and predetermined grasping speed.

According to an embodiment, the outfeed conveyor 16 is a belt conveyor but it may also consist of a chain conveyor. Still according to an embodiment, the outfeed conveyor 16 is connected to a downstream lug chain provided with pegs, where individual transferred longitudinal pieces of lumber 12 are placed, in between two subsequent pegs.

According to an embodiment, the feeding conveyor assembly 14, the positioning fingers 44, the grasping assembly 22 and the outfeed conveyor 16 are all connected to the controller 24, which controls, manages and synchronizes the overall operation of the wood board feeding system 10, including the speed of the feeding conveyor assembly 14 and outfeed conveyor 16, as the speed of the grasping assembly 22, as can be easily understood by a person skilled in the art.

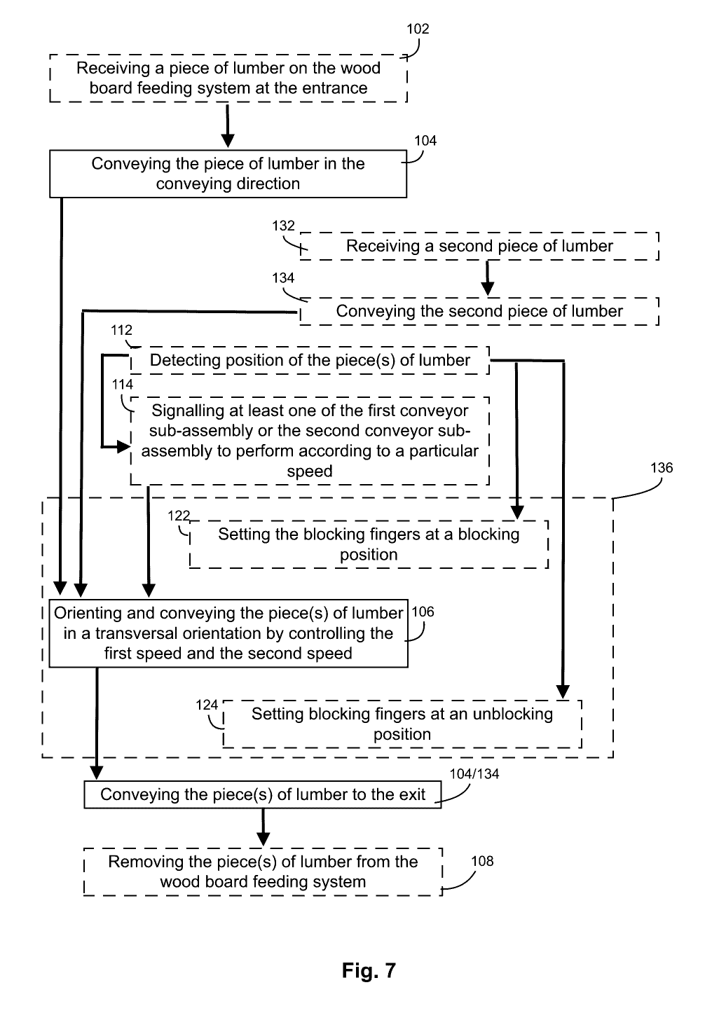

Referring to FIG. 7, according to another embodiment, a method of conveying and orienting a longitudinal piece of lumber performed by a wood board feeding system 10 is described.

First, at step 102, the method starts with the wood board feeding system 10 receiving the longitudinal piece of lumber at its entrance. The wood board feeding system has, as particularly illustrated on FIG. 1, an entrance and an exit. As discussed above, step 102 may be performed by the wood board feeding system 10 or by another component distinct from the wood board feeding system 10, or even manually.

At step 104, the wood board feeding system 10 conveys the longitudinal piece of lumber in the conveying direction using the first conveyor sub-assembly and the second conveyor sub-assembly. The first conveyor sub-assembly conveys the longitudinal piece of lumber about a first one of its ends according to a first speed. The second conveyor sub-assembly conveys the longitudinal piece of lumber about the second one of its end at a second speed.

At step 106, the wood board feeding system 10 controls the orientation of the longitudinal piece of lumber to place the longitudinal piece of lumber in a transversal orientation relatively to the conveying direction. The orientation of the longitudinal piece of lumber in the transversal orientation is performed by controlling the first and second speed, thereby independently controlling the conveying speeds of the two ends of the longitudinal piece of lumber allowing, for instance, to move one end of the longitudinal piece of lumber faster to catch up the other end and therefore have the longitudinal face of longitudinal piece of lumber substantially perpendicular to the conveying direction.

Once the longitudinal piece of lumber is positioned in a transversal orientation, the longitudinal piece of lumber is conveyed forward to the exit of the conveying area.

At step 108, the longitudinal piece of lumber is removed from the conveying area as discussed above. As for step 102, it may be performed by the wood board feeding system 10 or may be performed by a complementary device, or even manually.

According to another embodiment, the above method comprises the following steps:

At step 112, a detection system detects the position of the longitudinal piece of lumber conveying by the wood board feeding system 10.

At step 114, a controller connected to the detection system signals one of the first conveyor sub-assembly and the second conveyor sub-assembly to operate at a particular speed, or to modify its operating speed, in order to modify the orientation of the longitudinal piece of lumber, or in order to match the speed of the other sub-assembly to maintain the orientation of the longitudinal piece of lumber conveyed by the wood board feeding system 10.

According to another embodiment, the method comprises the following steps:

At step 122, the method further comprises setting blocking fingers in a blocking position when the longitudinal piece of lumber s in a non-transversal orientation; the blocking fingers in a blocking position hindering the transfer of the longitudinal piece of lumber towards the exit.

At step 124, the method further comprises setting the blocking fingers in an unblocking position when the longitudinal piece of lumber is in a transversal orientation; allowing the longitudinal piece of lumber to be conveyed to the exit by the wood board feeding system 10.

According to another embodiment, the method further comprises the following steps:

At step 132, the wood board feeding system 10 receives a second longitudinal piece of lumber. Step 132 may be performed while the first longitudinal piece of lumber is still on the wood board feeding system 10.

At step 134, the wood board feeding system 10 conveys the second longitudinal piece of lumber over the conveying area.

At step 136, the wood board feeding system 10 further controls the first speed, the second speed and the position of the blocking fingers to independently convey and controls the orientation of the first longitudinal piece of lumber and the second longitudinal piece of lumber.

As can be easily understood from the above-described, the embodiment of the wood board feeding system illustrated in the accompanying drawings is intended for minimizing components and assembling steps, while providing a suitable manner for easily, quickly and efficiently transferring longitudinal pieces of lumber from a feeding conveyor to an outfeed conveyor.

According to an embodiment, the wood board feeding system 10 and corresponding parts are made of substantially rigid materials, such as metallic materials (stainless steel, etc.), hardened polymers, composite materials, polymeric materials, and/or the like, so as to ensure a proper operation thereof depending on the particular applications for which the wood board feeding system 10 is intended and the different parameters in cause, as apparent to a person skilled in the art.

Another advantage resulting from the present description is that human intervention is substantially reduced in order to ensure a proper alignment, parallelism and spacing between a pair of neighboring longitudinal pieces of lumber, especially in cases when one is much longer than the other, or not fed parallel to each other, and that the resulting parallel longitudinal pieces of lumber can be thus be individually transferred from the feeding conveyor assembly 14 to a outfeed conveyor 16 in a much improved manner (faster, more reliable, etc.), thereby significantly improving productivity and other desirable factors related to the operation of a mill.

Of course, numerous modifications could be made to the above-described embodiments without departing from the scope of the description, as apparent to a person skilled in the art.

1. A wood board feeding system for positioning in parallel longitudinal pieces of lumber fed to the wood board feeding system in a substantially transversal manner, wherein the longitudinal pieces of lumber each comprise a first end and a second end opposite the first end, the wood board feeding system comprising:
a feeding conveyor assembly configured to receive and to convey the longitudinal pieces of lumber in a conveying direction which is substantially transversal to the longitudinal pieces of lumber, the feeding conveyor assembly comprising:
a first conveyor sub-assembly which comprises a first conveyor for conveying at least the first end of the longitudinal pieces of lumber and a first motor driving the first conveyor at a first conveying speed, and
a second conveyor sub-assembly which comprises a second conveyor for conveying at least the second end of the longitudinal pieces of lumber and a second motor driving the second conveyor at a second conveying speed, the first conveyor sub-assembly and the second conveyor sub-assembly being disposed side-by-side with respect to the conveying direction,
whereby at least one of the first conveyor sub-assembly and the second conveyor sub-assembly laterally positions a corresponding one of the first end and the second end of the longitudinal pieces of lumber such that the longitudinal pieces of lumber are positioned substantially in parallel to each other.

2. The wood board feeding system of claim 1, further comprising:
a detection system detecting positions of the longitudinal pieces of lumber on the feeding conveyor assembly and transmitting position signals accordingly; and
a controller receiving the position signals from the detection system and transmitting control signals to at least one of the first motor and the second motor thereby individually controlling the first conveying speed and the second conveying speed.

3. The wood board feeding system of claim 1, further comprising blocking fingers moveable between a blocking position and an unblocking position, wherein the blocking fingers, when in the blocking position, prevent the longitudinal pieces of lumber from being conveyed while, when in the unblocking position, allow the longitudinal pieces of lumber to be conveyed further in the conveying direction.

4. The wood board feeding system of claim 3, further comprising a conveyor surface, and wherein the blocking fingers, when in the blocking position, extend above the conveyor surface, and when in the unblocking position, are positioned flush with or under the conveyor surface.

5. The wood board feeding system of claim 3, further comprising:
a blocking finger motor; and
a shaft driven by the blocking finger motor driving one of the blocking fingers between the blocking position and the unblocking position.

6. The wood board feeding system of claim 1, further comprising:
an entrance;
an exit distant from the entrance; and
positioning fingers extending upwardly about the exit.

7. The wood board feeding system of claim 1, further comprises:
a conveying area having an entrance and an exit distant from the entrance; and
a grasping assembly located about the exit,
wherein the grasping assembly is adapted for removing the longitudinal pieces of lumber from the conveying area.

8. The wood board feeding system of claim 7, further comprises a grasping motor, wherein the grasping motor drives the grasping assembly at a grasping speed.

9. The wood board feeding system of claim 7, further comprising pegs located about one of the first conveyor and the second conveyor, wherein the pegs are adapted for entering in contact with the longitudinal pieces of lumber, thereby pushing the longitudinal pieces of lumber across the conveying area.

10. The wood board feeding system of claim 1, further comprising a third conveyor sub-assembly which comprises a third conveyor for conveying the longitudinal pieces of lumber and a third motor driving the third conveyor at a third conveying speed, wherein the third conveyor is positioned downstream of at least one of the first conveyor and the second conveyor.

11. The wood board feeding system of claim 1, wherein one of the first conveyor and the second conveyor consists in one of a chain conveyor and a belt conveyor.

12. The wood board feeding system of claim 1, wherein the first conveying speed is in a first direction and the second conveying speed is in a second direction opposite the first direction.

13. The wood board feeding system of claim 1, wherein the first conveying speed is different from the second conveying speed.

14. The wood board feeding system of claim 1, further comprising a conveyor surface adapted to receive the longitudinal pieces of lumber and the conveyor surface is in a substantially horizontal plane.

15. A method for positioning in parallel longitudinal pieces of lumber, each comprising a first end and a second end opposite the first end, the method comprising:
feeding and conveying the longitudinal pieces of lumber in a conveying direction from an entrance to an exit; and
positioning one of the first end and the second end of the longitudinal pieces of lumber such that the longitudinal pieces of lumber are positioned substantially in parallel to each other.

16. The method of claim 15, wherein the positioning comprises controlling at least one of a first conveying speed of a first end of the longitudinal pieces of lumber and a second conveying speed of a second end of the longitudinal pieces of lumber.

17. The method of claim 16, further comprising detecting positions of the longitudinal pieces of lumber and transmitting position signals accordingly to thereby control at least one of the first conveying speed and a second conveying speed.

18. A wood board feeding system for positioning in parallel longitudinal pieces of lumber fed to the wood board feeding system in a substantially transversal manner, wherein the longitudinal pieces of lumber each comprise a first end and a second end opposite the first end, the wood board feeding system comprising:
a first conveyor for conveying the first end of the longitudinal pieces of lumber at a first conveying speed, whereby the first conveyor laterally positions the first end of the longitudinal pieces of lumber such that the longitudinal pieces of lumber are positioned substantially in parallel to each other.
